(19) United States
(12) Patent Application Publication
(10) Pub. No.: US 2010/0159195 A1
(43) Pub. Date: Jun. 24, 2010

(54) HIGH REPELLENCY MATERIALS VIA NANOTOPOGRAPHY AND POST TREATMENT

(76) Inventors: Roger B. Quincy, III, Cumming, GA (US); Ali Yahiaoui, Roswell, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/343,909

(22) Filed: Dec. 24, 2008

(51) Int. Cl. B32B 3/00; B05D 3/00

(52) U.S. Cl. 428/141; 427/536

(57) ABSTRACT

A method is provided for making a high repellency material. In one embodiment the method includes the steps of providing a polymeric material having an external surface including particle-like nanotopography, etching the external surface with a high energy treatment; and depositing a fluorochemical onto the etched external surface by a plasma fluorination process.

### BACKGROUND OF THE INVENTION

Polymeric films, nonwoven fabrics, and laminates thereof are useful for a wide variety of applications, such as in wipers, towels, industrial garments, medical garments, medical drapes, sterile wraps, etc. It is not always possible, however, to produce these materials having all the desired attributes for a given application. For example, in some applications, materials need to have so-called super-hydrophobicity, i.e., extremely high water repellency. An example of a natural material that exhibits super-hydrophobicity is a Lotus leaf. Achieving the levels of super-hydrophobicity demonstrated by the Lotus leaf has heretofore been difficult with synthetic polymeric materials.

Accordingly, there is a need for simple and inexpensive methods of making and/or treating polymeric films, fibers, nonwoven fabrics, and laminates thereof to achieve super-hydrophobicity.

### SUMMARY OF THE INVENTION

In accordance with one embodiment of the present invention, a method of making a high repellency material is provided, along with high repellency materials made according to the process and personal care products containing the high repellency materials. The method includes the steps of: providing a polymeric material having an external surface, the external surface including particle-like nanotopography; etching the external surface with a high energy surface treatment; and depositing a fluorochemical onto the etched external surface by a plasma fluorination process.

In one embodiment, the polymeric material may include between about 1 and about 20 weight percent of a polyhedral oligomeric silsesquioxane compound. The polymeric material may further include between about 40 and about 99 weight percent of a base polymer. The base polymer may be a polyolefin, for example, polyethylene, polyethylene, polybutylene, and so forth. For example, the polymeric material may be in the form of a film, fibers, and so forth.

In one embodiment, the step of providing the polymeric material may include a step of blending the polyhedral oligomeric silsesquioxane additive with the base polymer to form a blend, followed by extruding the blend into the polymeric material having the external surface. In another embodiment, the step of providing the polymeric material may include a step of applying a nano-particle treatment to the external surface of the polymeric material. In a further embodiment, the step of providing the polymeric material may include a high energy surface treatment.

In one embodiment, the high energy surface treatment may be a plasma treatment. The plasma may, for example, include a blend of an inert gas and a reactive gas. As another example, the plasma may include a blend of oxygen and argon, for example from about 1 to about 4 parts by weight oxygen and from about 1 to about 4 parts by weight argon.

In one embodiment, the fluorochemical may include fluoracrylate monomer.

In accordance with one embodiment of the present invention, a high repellency synthetic polymeric article is provided. The article has particle-like nanotopography on an external polymeric surface of the article and a fluorochemical applied by plasma deposition. The external polymeric surface demonstrates a contact angle to water of greater than 140 degrees. In one embodiment, the article is a film.

In accordance with one embodiment of the present invention, a method of making a high repellency material includes the steps of: providing a polymeric material having an external surface; etching the external surface with a high energy treatment; applying a nano-particle surface treatment formulation to the etched external surface of the polymeric material; and thereafter applying a fluorochemical onto the nano-particle treatment. In a further embodiment, the nano-particle surface treatment formulation may include silica nano-particles. In another further embodiment, the high energy treatment may include plasma treatment. In an even further embodiment, the fluorochemical may include fluoracrylate monomer.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 depicts scanning electron micrographs (SEMs) and contact angles at various stages of preparing a plasma fluorinated polypropylene film without nanotopography;

FIG. 2 depicts SEMs of polypropylene film and polypropylene films with various internal additives;

FIG. 3 depicts surface composition data for the films shown in FIG. 2;

FIG. 4 depicts SEMs and contact angles at various stages of preparing a plasma fluorinated polypropylene film with nanotopography generated with an internal additive;

FIG. 5 depicts SEMs and contact angles at various stages of preparing a plasma fluorinated polypropylene film with internal additive generated and plasma etched nanotopography;

FIG. 6 depicts SEMS and contact angles at various stages of preparing a plasma fluorinated polypropylene film with plasma etched nanotopography;

FIG. 7 depicts SEMS and contact angles at various stages of preparing a plasma fluorinated polycarbonate film with a plasma etched and coating nanotopography;

FIG. 8 depicts SEMS of spunbond polypropylene fibers both with and without nanotopography generated with an internal melt additive;

FIG. 9 depicts SEMS of spunbond polypropylene fibers with and without various internal additives; and

FIG. 10 depicts SEMs of meltblown polypropylene/polybutylene fibers with and without various internal additives.

Repeat use of reference characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment may be used in or on another embodiment to yield a still further embodiment. Thus, it is intended that the present invention cover such modifications and variations.

The high repellency materials of the present invention may be prepared as any of a variety of polymeric materials, including, for example, fibers, nonwoven fabrics, films, and nonwoven/film laminates. The polymer films and/or fibers may be formed by any of the conventional processes for forming films and/or fibers. The process will typically include extrusion of a polymer by a conventional extruder into the desired material. The extrusion temperature may generally vary depending on the type of polymers employed. For example, a molten thermoplastic material may be fed from the extruders through respective polymer conduits to a conventional fiber or film die.

The high repellency material is suitably formed with a surface characterized by a high degree of nanotopography. Nanotopography may be achieved by various processes, including addition of an internal additive during extrusion, etching of an external surface following extrusion, and/or deposition of a nano-particle coating to the external surface following extrusion, combinations thereof, and so forth. The nanotopography is characterized by the presence on the surface of particle-like surface features. The particle-like surface features may range in size (measured by largest dimension) from about 0.01 microns to about 10 microns, more specifically from about 0.05 microns to about 5 microns, and even more specifically from about 0.1 microns to about 1.0 microns. The particle-like surface features may further have a surface density of from about 0.001 particle-like surface features per square micron to about 2000 particle-like surface features per square micron, specifically from about 0.01 particle-like surface features per square micron to about 500 particle-like surface features per square micron, more specifically from about 0.1 particle-like surface features per square micron to about 100 particle-like surface features per square micron, and even more specifically from about 1 to about 12 particle-like surface features per square micron.

Nanotopography on an external surface of synthetic polymer films and/or fibers may be achieved by using an internal additive such as a polyhedral oligomeric silsesquioxane (POSS), shown below with R as a functional group. Various functional groups (R) may be added to the POSS molecule, including hydrogen, methyl, ethyl, butyl, isobutyl, and so forth. Various POSS materials are available, for example, from Hybrid Plastics of Hattiesburg, Miss. In one embodiment, the functional group may be an octaisobutyl (OIB) group, thus forming octaisobutyl polyhedral oligomeric silsesquioxane, shown below.

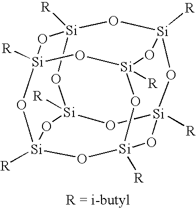

During the extrusion process, the POSS may segregate to the outer surface of the film or fiber and form a particle-like surface nanotopography. The particle-like surface features formed by POSS may range in size (measured by largest dimension) from about 0.1 micron to about 1.0 microns. In some embodiments, the particle-like surface features formed by POSS may have a surface density of from about 1 to about 12 particle-like surface features per square micron.

Nanotopography on an external surface of synthetic polymers, for example films, fibers, and so forth, may also be generated by subjecting the surface to a high-energy surface etching treatment such as a glow discharge (GD) from a corona or plasma treatment system. The high energy etching treatment serves to “clean” the synthetic polymeric surface of “loose” weak boundary layers made of contaminants and short chain oligomers. The high energy treatment can also generate radicals on the surface of the laminate, which can subsequently enhance surface attachment through covalent bonding of polymerizing fluorinated monomer. By way of example, the high energy treatment may be a radio frequency (RF) plasma treatment. Alternatively, the high energy treatment may be a dielectric barrier corona treatment. Without wishing to be bound by theory, it is believed that exposure of the polymer surface to a high energy treatment results in alterations of the surfaces, thereby raising the surface energy of the surface and forming radicals that can promote interfacial adhesion and polymerization of fluorinated monomers. These functions are attributed to the high energy treatment through ablation of contaminants, the removal of atoms, and the breaking of bonds that can generate free radicals, polar moieties and ionic species. This, in turn, improves the subsequent uniform deposition of fluorinated compounds onto the surface; that is, the surface may be saturated with fluorinated compounds. Thus, fluorinated compounds can be deposited on the surface of the films and/or fibers on exposed areas.

The strength of the high energy surface treatment may be varied in a controlled manner across at least one dimension of the material. For example, the strength of the high energy treatment can be readily varied in a controlled manner by known means. For example, a corona apparatus having a segmented electrode may be employed, in which the distance of each segment from the sample to be treated may be varied independently. As another example, a corona apparatus having a gap-gradient electrode system may be utilized; in this case, one electrode may be rotated about an axis which is normal to the length of the electrode. Other methods also may be employed; see, for example, “Fabrication of a Continuous Wettability Gradient by Radio Frequency Plasma Discharge”, W. G. Pitt, J. Colloid Interface Sci., 133, No. 1, 223 (1989); and “Wettability Gradient Surfaces Prepared by Corona Discharge Treatment”, J. H. Lee, et al., Transactions of the 17th Annual Meeting of the Society for Biomaterials, May 1-5, 1991, page 133, Scottsdale, Ariz.

The high energy surface treatment may further be achieved by treating the external surface with a gaseous plasma treatment. Inert gases, including argon, helium, nitrogen, and so forth, for example, can be energized to form plasma. Ions and electrons in the plasma can react with the external surface of the synthetic polymer films and/or fibers to create a super-clean or etched surface. Introduction of a reactive gas, such as oxygen, further enhances the ability of the plasma to react with the external surface of the film or fiber. The weight ratio of inert gas to reactive gas may range 1 to 4 and 4 to 1. A 1 to 1 weight ratio of argon to oxygen energized to a plasma treatment has been found to be particularly effective in etching of the external surface of polypropylene and polycarbonate materials. The plasma treatment may be conducted, for example, in a 500 Watt plasma chamber (model PS0150E, from Air Coating Technology). The power input may range, for example, from about 100 to about 500 Watts over an exposure time, for example, from about 1 to about 4 minutes.

Another method of creating nanotopography on the surface of a material is application of a topical nano-particle treatment, for example, a silica nanoparticle coating formulation. One suitable silica nanoparticle coating formulation is COL.9® DS 1100X (available from BASF). A wetting agent may be used in the treatment formulation to enhance coverage of the surface to be treated. One suitable wetting agent is BERMOCOLL E230 FQ, available from BASF of Stamford, Conn. The topical nanoparticle treatment may be prepared, applied to the surface to be treated, and subsequently dried by techniques known to those skilled in the art, including, for example, dip and squeeze treatment, spray treatment, application with a rod, and so forth.

Once the nanotopography is formed and after the high energy surface treatment has been completed, the material having a high degree of nanotopography may be chemically treated with reactive plasma to provide the final super-hydrophobic surface. The surface having a high degree of nanotopography is subjected to deposition of monomer compounds that are subsequently grafted to the surface via irradiation from a radiation source (e.g., electron beam, gamma, and UV radiation and glow discharge plasma). The monomer compounds are, in one particular embodiment, fluorinated compounds. The monomer deposition process generally involves (1) atomization or evaporation of a liquid fluorinated compound (e.g., a fluorinated monomer, fluorinated polymers, perfluorinated polymers, and the like) in a vacuum chamber, (2) depositing or spraying the fluorinated compound on the surface having the high degree of nanotopography, and (3) polymerization of the fluorinated compound by exposure to a radiation source, such as electron beam, gamma radiation, or ultraviolet radiation.

Exemplary fluorinated monomers include 2-propenoic acid, 2,2,3,3,4,4,5,5,6,6,7,7,8,8,8-pentadecafluorooctyl ester; 2-propenoic acid, 2-methyl-2,2,3,3,4,4,5,5,6,6,7,7,8,8,8-pentadecafluorooctol ester; 2-propenoic acid, pentafluoroethyl ester; 2-propenoic acid, 2-methyl-pentafluorophenyl ester; 2,3,4,5,6-Pentafluorostyrene; 2-Propenoic acid, 2,2,2-trifluoroethyl ester; and 2-propenoic acid, 2-methyl-2,2,2-trifluoroethyl ester. Other suitable monomers include fluoroacrylate monomers having the general structure of:

CH₂═CROCO(CH₂)ₓ(CₙF₂ₙ₊₁)

wherein n is an integer ranging from 1 to 12, x is an integer ranging from 1 to 8, and R is H or an alkyl group with a chain length varying from 1 to 16 carbons. In many instances, the fluoroacrylate monomer may be comprised of a mixture of homologues corresponding to different values of n. An example of a suitable fluoroacrylate monomer is perfluorodecyl acrylate (PFDEA) (available as CAS No. 27905-45-9 from Aldrich), which was used for all the plasma fluorochemical deposition in the examples below. Other suitable monomers are 1H,1H,2H,2H-heptadecafluorodecyl acrylate and 3,3,4,4,5,5,6,6,7,7,8,8,9,9,10,10,10-heptadecafluorodecyl methacrylate.

Monomers of this type may be readily synthesized by one of skill in the chemical arts by applying well-known techniques. Additionally, many of these materials are commercially available. The DuPont Corporation of Wilmington, Del. sells a group of fluoroacrylate monomers under the trade name ZONYL®. These agents are available with different distributions of homologues. More desirably, ZONYL® agents sold under the designation “TA-N” and “TM” may be used in the practice of the present invention.

No matter the particular fluorinated agent used, the fluorinated agent is evaporated (or atomized) and condensed (or sprayed) on the surface having the high degree of nanotopography according to a monomer deposition process. One particularly suitable monomer deposition process is described by Mikhael, et al. in U.S. Pat. No. 7,157,117, which is incorporated by reference to the extent that it does not conflict with the present application. In this monomer deposition process, a conventional vacuum chamber is modified to enable a plasma-field pretreatment, followed by monomer deposition, and then radiation curing of a porous substrate in a continuous process. Typically, the material being processed is processed entirely within a vacuum chamber while being spooled continuously between a feed reel and a product reel. The material can first be passed through a cold compartment to chill it to a temperature sufficiently low to ensure the subsequent cryocondensation of the vaporized fluorinated agent. The material is then passed through a plasma pretreatment unit and can immediately thereafter (within no more than a few seconds, preferably within milliseconds) pass through a flash evaporator, where it is exposed to the fluorinated agent vapor for the deposition of a thin liquid film over the cold material. The fluorinated agent film is then polymerized by radiation curing through exposure to an electron beam unit and passed downstream through another (optional) cooled compartment.

Exposure to the electron beam after depositing the fluorinated agent on the surface of the material being treated results in the grafting of the fluorinated agent to the substrate. One exemplary electron beam apparatus is manufactured under the trade designation CB 150 ELECTROCURTAIN® by Energy Sciences Inc. of Wilmington, Mass. This equipment is disclosed in U.S. Pat. Nos. 3,702,412; 3,769,600; and 3,780,308; which are hereby incorporated by reference. Although electron beam radiation is generally preferred, other radiations sources could be utilized, such as gamma radiation or ultraviolet radiation.

Generally, the material being treated may be exposed to an electron beam operating at an accelerating voltage from about 80 kilovolts to about 350 kilovolts, such as from about 80 kilovolts to about 250 kilovolts. In one particular embodiment, the accelerating voltage is about 175 kilovolts. The material being treated may be irradiated from about 0.1 million rads (Mrad) to about 20 Mrad, such as from about 0.5 Mrad to about 10 Mrad. Particularly, the substrates may be irradiated from about 1 Mrad to about 5 Mrad.

As stated, the applied radiation causes a reaction between the deposited fluorinated agent and polymers of the film and/or fiber surface. As a result, the fluorinated agent may become graft copolymerized (or grafted) and/or crosslinked to the surface of the polymer fibers and/or film having the high degree of nanotopography. This particular combination of post-treatment adds a high degree of water repellency to the surface having the high degree of nanotopography.

Accordingly, the present inventors have found that the treated material can exhibit a contact angle of greater than about 130 degrees. Even more desirably, the present inventors have found that the treated material can exhibit a contact angle of greater than about 140 degrees, i.e., a contact angle essentially equivalent to that of a lotus leaf.

If desired, the highly repellent material of the present invention may be applied with various other treatments to impart desirable characteristics. For example, the highly repellant material may be treated with colorants, antifogging agents, lubricants, and/or antimicrobial agents.

The highly repellant material of the present invention may be used in a wide variety of applications. For example, the highly repellant material may be incorporated into a “medical product”, such as gowns, surgical drapes, facemasks, head coverings, surgical caps, shoe coverings, sterilization wraps, warming blankets, heating pads, and so forth. Of course, the highly repellant material may also be used in various other articles. For example, the highly repellant material may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipes, and so forth; medical absorbent articles, such as garments, fenestration materials, underpads, bed pads, bandages, absorbent drapes, and medical wipes; food service wipers; clothing articles; pouches, and so forth. Materials and processes suitable for forming such articles are well known to those skilled in the art. Absorbent articles, for instance, typically include a substantially liquid-impermeable layer (e.g., outer cover), a liquid-permeable layer (e.g., bodyside liner, surge layer, etc.), and an absorbent core. In one embodiment, for example, the highly repellant material of the present invention may be used to form an outer cover of an absorbent article.

Although the basis weight of the highly repellant material of the present invention may be tailored to the desired application, it generally ranges from about 10 to about 300 grams per square meter (“gsm”), in some embodiments from about 25 to about 200 gsm, and in some embodiments, from about 40 to about 150 gsm.

### Contact Angle Test Method

Contact angle measurements were made on samples of material cut to about 2.54 centimeters wide by 7.62 centimeters long. The samples were placed on a flat metal platform with horizontal and vertical adjustment features. Drops of distilled water (distilled to 18.2 MΩcm using a Milli-Q Water Purification System available from Millipore of Billerica, Mass.) were manually delivered from a 100 microliter syringe to the surface of the sample. Side images of the drops of water on the sample surface were obtained with a camera (Leica Z6 APO A optical zoom system from Leica Microsystems) that was interfaced to a computer via a SONY camera control unit. Auxiliary lighting probes were used to improve the image of the drop. The contact angle at the water/surface interface may be measured from the photo using a standard method, e.g., a protractor.

### EXAMPLES

The inventive materials and methods of making them are exemplified by the following examples. As with the figures, the examples are not meant to be limiting.

Samples of films were cast on a 25.4-centimeter cast film line using a Leistritz twin screw extruder. The base resin was a polypropylene homopolymer, identified as Pro-fax® 6323, a 12 melt flow rate polypropylene homopolymer available from LyondellBasell, having offices in Rotterdam, The Netherlands. The target film thickness was 0.1 millimeters. Several additives were used at various levels. One additive was a nano-reinforced polypropylene concentrate containing 80 percent by weight polypropylene and 20 percent by weight octaisobutyl (OIB) polyhedral oligomeric silsesquioxane (POSS), available as MS0825 nano-reinforced polypropylene from Hybrid Plastics of Hattiesburg, Miss. Another additive was an internal fluorochemical (IFC) polypropylene concentrate containing 80 percent by weight polypropylene and 20 percent by weight fluorochemical (available from Standridge Chemical Corporation, Social Circle, Ga.). The base resin and the two additives were used to make films having the compositions shown in Table 1.

TABLE 1
Film Sample Compositions

| | | OIB- | |
|---|---|---|---|
| | Polypropylene | POSS | fluorochemical |
| Film Sample | weight % | weight % | % |
| PP | 100 | 0 | 0 |
| POSS/PP | 90 | 10 | 0 |
| IFC/PP | 98 | 0 | 2 |
| POSS + IFC/PP | 88 | 10 | 2 |

The polypropylene film samples described above and polycarbonate film samples were subjected to an argon/oxygen plasma treatment (Plasma Science 500 W plasma chamber, model PS0150E, from Air Coating Technology) to clean and etch the polymer film surface to produce surface nanotopography. The process conditions were 100% power input with an argon to oxygen gas weight ratio of 1 to 1 and an exposure time of 4 minutes to the continuous plasma. The base pressure of the chamber was evacuated to 0.1 torr and reached 0.86 torr during the plasma process. This plasma treatment also increased the wettability of the film surface as shown by the contact angle data. The increased wettability of the polypropylene and polycarbonate film samples provided a better surface for subsequent treatment of the surface with a silica nanoparticle coating formulation (COL.9® DS 1100X from BASF, designated herein as COL.9). Samples exposed to this plasma process are labeled “Plasma” in Table 2.

The polypropylene and polycarbonate film samples were also subjected to reactive fluorochemical deposition via ion-mask™ plasma surface enhancement treatment (P2i Ltd., Abingdon, Oxfordshire, UK). In Table 2 below, samples subjected to reactive plasma fluorochemical deposition are designated as “PF”. Scanning electron microscopy (SEM) and X-ray photoelectron spectroscopy (XPS) were used to evaluate the surface of the various film codes. For SEM, the samples were gold coated to help mitigate charging and imaged at a tilt angle of 45 degrees.

Films Treated with COL.9:

“Plasma PP Film+COL.9 +PF”: A #20 single wound coating rod was used to apply the COL.9® DS 1100X formulation to the surface of a 4-inch by 5.5-inch piece of the PP Film (100% Pro-fax 6323 PP) that had been “Plasma” treated. The coated film was dried in an oven at 90° C. for 13 minutes. The increase in mass for the dry coated piece of film was used to determine that about 17% of the COL.9 was applied to the film.

“Plasma PP Film+E230 & dilute COL.9”: 75.6 grams of the COL.9® DS 1100X formulation was placed in a 300 ml Pyrex beaker and Milli-Q distilled water was added to give a total weight of 225.2 grams. The diluted COL.9 liquid was stirred with a motorized propeller for 30 minutes while being heated to 55° C. Then 0.50 gram of BERMOCOLL E230 FQ (a water soluble cellulose derivative (wetting agent), available from Akzo Nobel, Stamford, Conn.) was added and the liquid was cooled while stirring was continued. The pH of this formulation was measured at 9.1 and the viscosity was measured at 75 cP using a Brookfield Model DV-1 viscometer with an LV-2 spindle set at 50 rpm. The formulation was applied with a #20 single wound coating rod to the surface of a 4-inch by 5.5-inch piece of the PP Film (100% Pro-fax 6323 PP) that had been “Plasma” treated. The coated film was dried in an oven at 90° C. for 10 minutes. The increase in mass for the dry coated piece of film was used to determine that about 3.5% of the COL.9 was applied to the film.

“Plasma PC Film+E230 & COL.9” and “Plasma PC Film+E230 & COL.9+PF”: 250.2 grams of the COL.9® DS 1100X formulation was placed in a beaker and heated to 55° C. while stirring with a motorized propeller. Then 0.50 gram of BERMOCOLL E230 FQ was added and the liquid was cooled while stirring was continued. The pH of this formulation was measured at 8.6 and the viscosity was measured at 388 cP using a Brookfield Model DV-1 viscometer with an LV-2 spindle set at 50 rpm. The formulation was applied with a #20 single wound coating rod to the surface of a 2.5-inch by 7-inch piece of polycarbonate film (PC Film) that had been “Plasma” treated. The coated film was dried in an oven at 90° C. for 15 minutes. The increase in mass for the dry coated piece of film was used to determine that about 7.9% of the COL.9 was applied to the film.

“Plasma PC Film+E230 & dil. COL.9+PF”: 75.6 grams of the COL.9® DS 1100X formulation was placed in a 300 ml Pyrex beaker and Milli-Q distilled water was added to give a total weight of 225.2 grams. The diluted COL.9 liquid was stirred with a motorized propeller for 30 minutes while being heated to 55° C. Then 0.50 gram of BERMOCOLL E230 FQ was added and the liquid was cooled while stirring was continued. The pH of this formulation was measured at 9.1 and the viscosity was measured at 75 cP using a Brookfield Model DV-1 viscometer with an LV-2 spindle set at 50 rpm. The formulation was applied with a #20 single wound coating rod to the surface of a 2.2-inch by 7-inch piece of polycarbonate film (PC Film) that had been “Plasma” treated. The coated film was dried in an oven at 90° C. for 34 minutes. The increase in mass for the dry coated piece of film was used to determine that about 1.6% of the COL.9 was applied to the film.

“Plasma PC Film+COL.9” and “Plasma PC Film+COL.9+PF”: A #20 single wound coating rod was used to apply the COL.9® DS 1100X formulation to the surface of a 3.5-inch by 5-inch piece of polycarbonate film (PC Film) that had been “Plasma” treated. The coated film was dried in an oven at 90° C. for 2 hours. The increase in mass for the dry coated piece of film was used to determine that about 8% of the COL.9 was applied to the film.

The contact angle data for the treated films are shown in the following Table 2, with averages and standard deviation for each sample provided at the bottom of the columns of individual contact angle data points.

TABLE 2
Contact Angle Data

| PP Film | IFC/PP Film | POSS/PP Film | POSS + IFC/PP Film | PP Film + PF | POSS/PP Film + PF |
|---|---|---|---|---|---|
| 96 | 119 | 98 | 122 | 113 | 133 |
| 95 | 128 | 97 | 120 | 112 | 143 |
| 94 | 115 | 100 | 115 | 113 | 143 |
| | 121 | 98 | 115.5 | 118 | 134 |
| | 120 | 100 | 111 | 112 | 132 |
| | 121 | 97 | 118 | 114 | 135 |
| | 117 | 105 | 119 | 112 | 137 |
| | 121 | 105 | 107 | | 133 |
| | 118 | | 102 | | 135 |
| | 107 | | 125 | | 138 |
| | | | 121 | | 129 |
| | | | 126 | | |
| | | | 124 | | |
| 95.0 | 118.7 | 100.0 | 117.3 | 113.4 | 135.6 |
| 1.0 | 5.4 | 3.3 | 7.2 | 2.1 | 4.4 |

| Plasma | Plasma PP Film + | POSS/PP Film + | POSS/PP Film + | POSS/PP Film + | Plasma PP Film + | Plasma PP Film + |
|---|---|---|---|---|---|---|
| PP Film | PF | Plasma | Plasma + PF | PF | E230 & dilute COL.9 | COL.9 + PF |
| 77 | 114 | 41 | 149 | 144 | 72 | 111 |
| 79 | 118 | 38 | 147 | 145 | 87 | 115 |
| 82 | 110 | 43 | 146 | 136 | 90 | 112 |
| 73 | 117 | 45 | 153 | 138 | 83 | 115 |
| 81 | 112 | 66 | 150 | 146 | 80 | 111 |
| | | 40 | 143 | 140 | 94 | 106 |
| | | 40 | 153 | 132 | | 112 |
| | | 48 | 139 | 138 | | 114 |
| | | 46 | 137 | 131 | | 111 |
| | | 50 | 134 | | | |
| | | 47.5 | 145 | | | |
| | | 51.5 | 139 | | | |
| 78.4 | 114.2 | 46.3 | 144.6 | 138.9 | 84.3 | 111.9 |
| 3.6 | 3.3 | 7.5 | 6.3 | 5.4 | 7.8 | 2.8 |

| Plasma | Plasma PC Film + | Plasma PC Film + | Plasma PC Film + | Plasma PC Film + E230 | Plasma PC | Plasma PC Film + |
|---|---|---|---|---|---|---|
| PC Film | PF | E230 & COL.9 | E230 & COL.9 + PF | & dil. COL.9 + PF | Film + COL.9 | COL.9 + PF |
| 66 | 110 | 60 | 119 | 111 | 65 | 122 |
| 65 | 118 | 61 | 118 | 113 | 63 | 122 |
| 66 | 113 | 67 | 118 | 110 | 67 | 118 |
| 59 | 117 | 70 | 117 | 111 | 69 | 118 |
| 63 | 118 | 66 | 118 | 111 | 64 | 114 |
| 61 | | | | 106 | | |
| 63.0 | 115.2 | 64.8 | 118.0 | 110.3 | 65.6 | 118.8 |
| 2.5 | 3.6 | 4.2 | 0.7 | 2.3 | 2.4 | 3.3 |

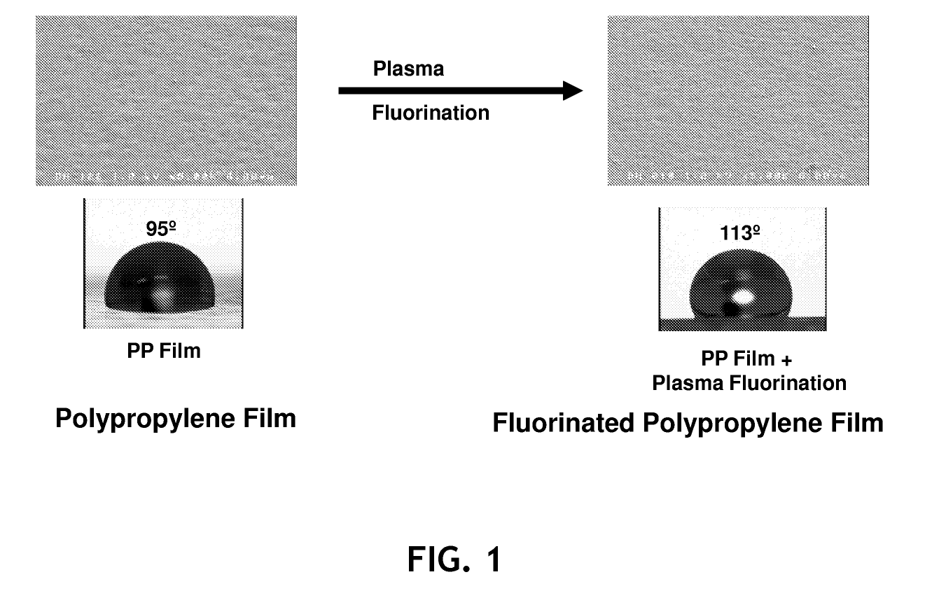

Referring to FIG. 1, scanning electron micrographs (SEMs) and contact angles are shown for the PP Film and the PP Film+PF. Neither film has any nanotopography and it is shown that reactive deposition of the fluorochemical on the control polypropylene film increases the contact angle by 18 degrees.

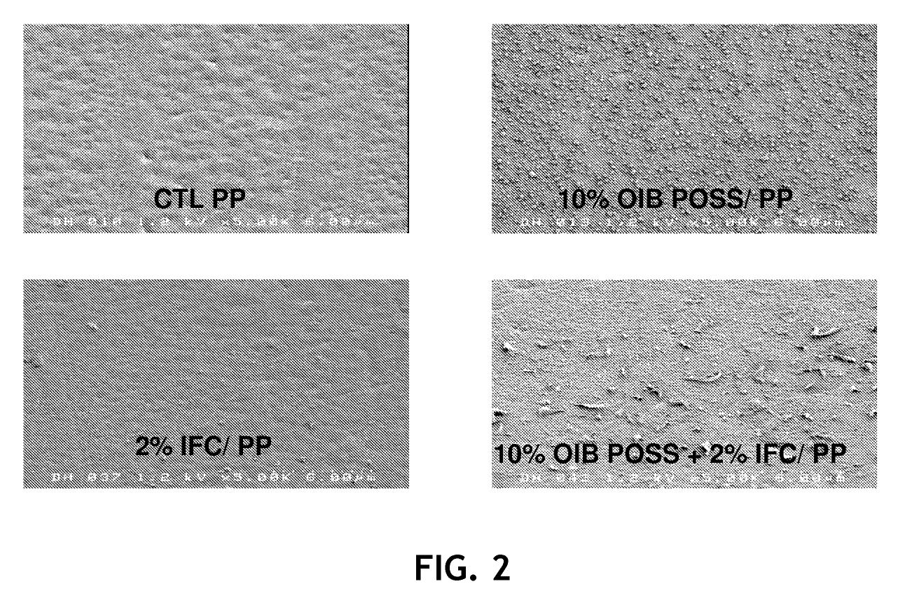

Referring to FIG. 2, SEMs of the PP Film (CTL PP), the POSS/PP Film (10% OIB POSS/PP), the IFC/PP Film (2% IFC/PP), and the POSS+IFC/PP Film (10% OIB POSS+2% IFC/PP) are shown. Surprisingly, the POSS/PP sample shows well dispersed and uniform nanotopography, while the POSS+IFC/PP sample has topography that is larger, less uniform, and less well dispersed. It is evident that the internal fluorochemical inhibits the formation of well dispersed and uniform nanotopography.

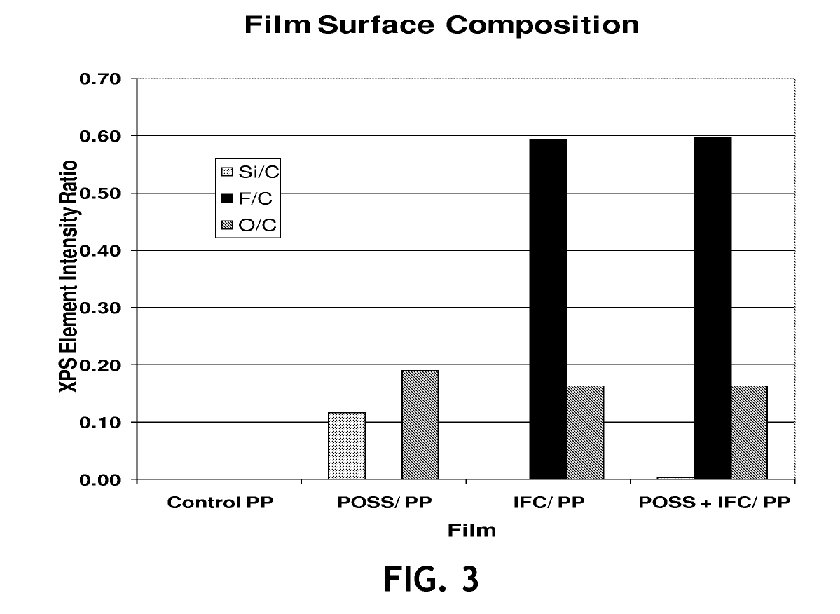

Referring to FIG. 3, surface composition data for the films shown in FIG. 2 is shown. Of note, significant levels of silicon, indicating the presence of POSS, were detected in the POSS/PP, while only slight levels of silicon were detected in the POSS+IFC/PP sample. Again, it is evident that the internal fluorochemical inhibits the migration of the POSS to the surface of the film and subsequent formation of the well dispersed and uniform nanotopography.

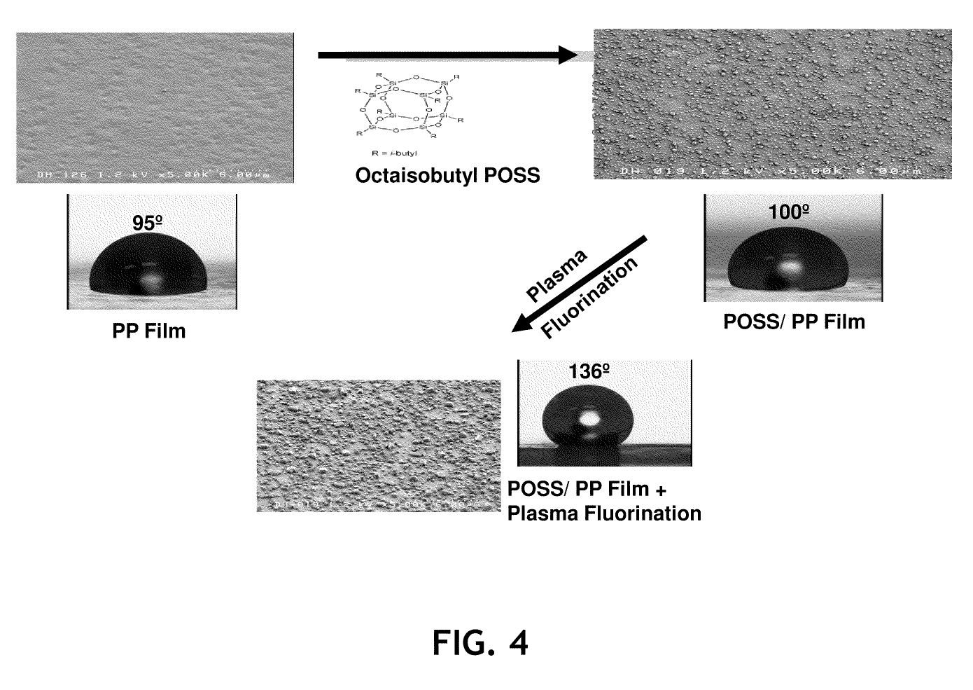

Referring to FIG. 4, SEMs and contact angles at various stages of preparing the POSS/PP Film+PF sample are shown. As noted above, this sample was prepared by extruding a blend of OIB POSS and polypropylene into a film that produced nanotopography (POSS/PP Film), and then plasma fluorinating the film (POSS/PP Film+PF). Of note, use of the OIB POSS to make the POSS/PP Film resulted in a contact angle increase of 5 degrees. Subsequent plasma fluorination of the POSS/PP Film resulted in a contact angle increase of 36 degrees. Additionally, a tape test (applying and removing standard transparent tape to the surface of the film to test durability of a treatment) showed that the nanotopography on the surface of the POSS/PP Film was readily removed by the tape. However, after plasma fluorination, the nanotopography was found to be much more durable, showing little effect from the tape test.

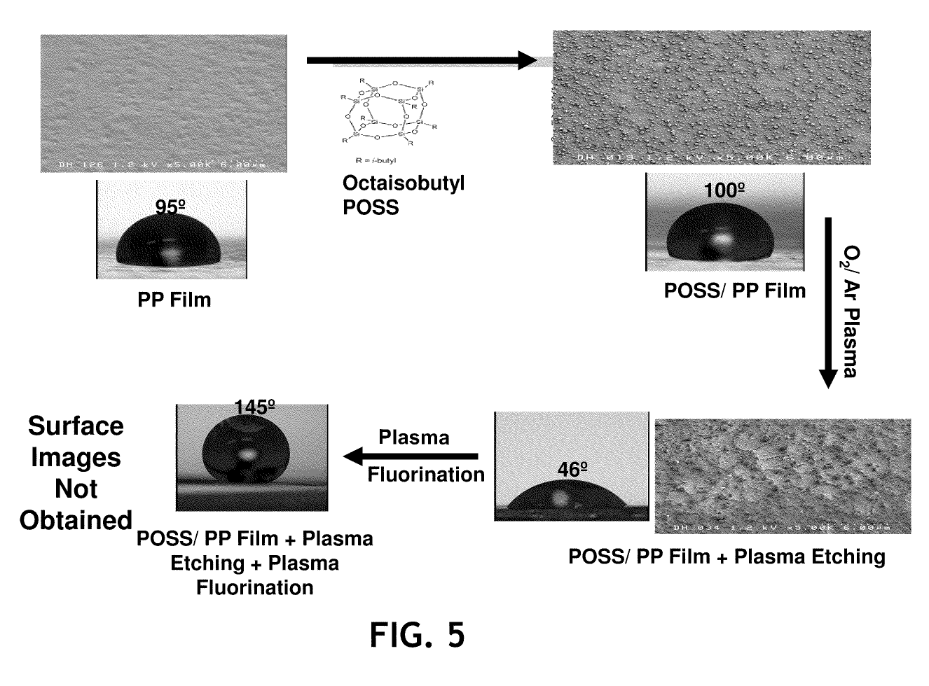

Referring to FIG. 5, SEMs and contact angles at various stages of preparing the POSS/PP Film+Plasma+PF sample are shown. As noted above, this sample was prepared by extruding a blend of OIB POSS and polypropylene into a film that produced nanotopography (POSS/PP Film), etching the film with high energy oxygen/argon plasma (POSS/PP Film+Plasma), and plasma fluorinating the etched film (POSS/PP Film+Plasma+PF). The steps are the same as shown in FIG. 4 with the addition of the plasma etching step. Of note, the etching step resulted in a contact angle decrease of 54 degrees relative to the un-etched film. However, subsequent plasma fluorination resulted in a contact angle increase of 99 degrees relative to the etched film.

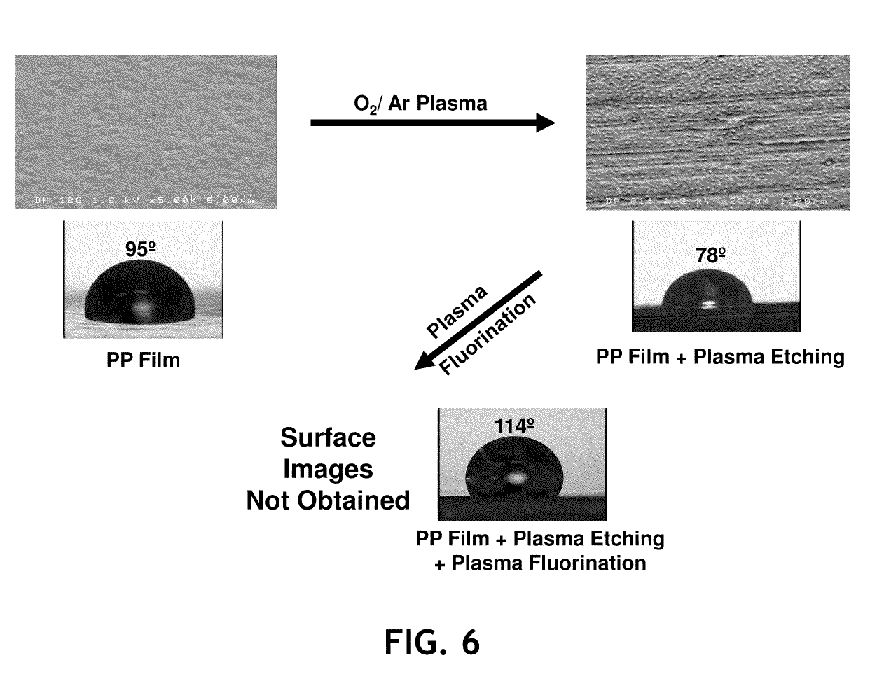

Referring to FIG. 6, SEMS and contact angles at various stages of preparing the Plasma PP Film+PF sample are shown. As noted above, these samples were prepared by extruding polypropylene into a film (PP Film), etching the film with high energy oxygen/argon plasma to provide nanotopography (Plasma PP Film), and plasma fluorinating the etched film (Plasma PP Film+PF). The steps are the same as shown in FIG. 5 with the exception that no POSS was used in preparing the initial film. Of note, the fluorinated nanotopography for this sample demonstrated a contact angle of only 114 degrees.

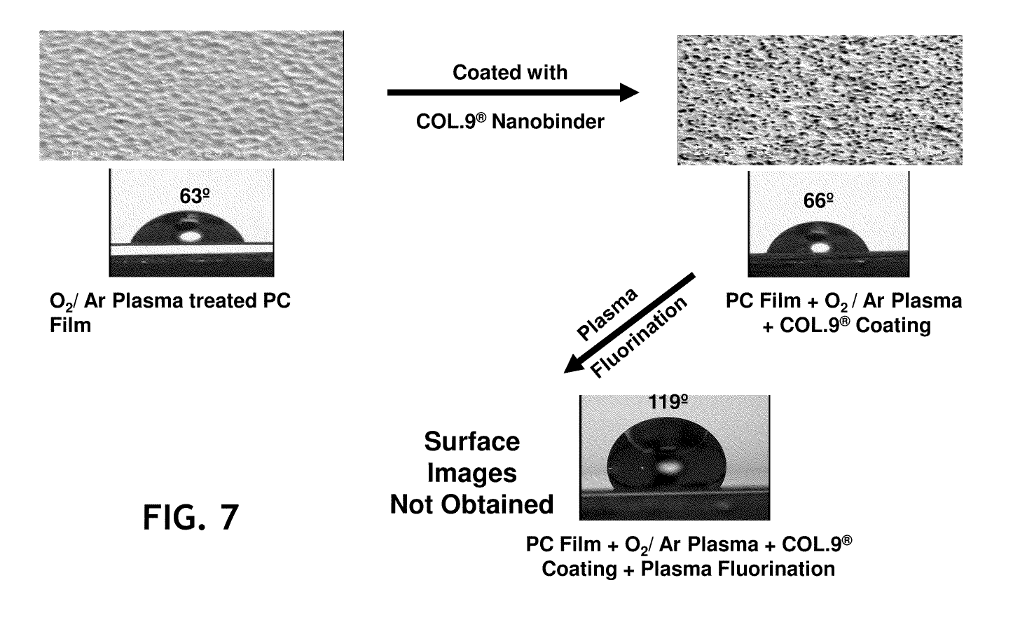

Referring to FIG. 7, SEMS and contact angles at various stages of preparing the Plasma PC Film+COL.9+PF sample are shown. As noted above, these samples were prepared by etching a polycarbonate (PC) film with high energy oxygen/argon plasma (Plasma PC Film), coating the etched film with COL.9 as described above (Plasma PC Film+COL.9) to provide nanotopography, and plasma fluorinating the coated film (Plasma PC Film+COL.9+PF). Of note, the external treatment method of providing the nanotopography surface resulted in a contact angle increase of 56 degrees.

PP Spunbond Fiber Samples:

Spunbond polypropylene (ExxonMobil Escorene 3155, nominal melt flow rate of 35) fiber samples were made with standard spunbonding conditions.

Spunbond polypropylene fibers were also produced containing 5 percent and 10% OIB POSS (blend of Escorene 3155 polypropylene and Hybrid Plastics MS0825 nanoreinforced polypropylene). Further samples were produced that contained 5 percent OIB POSS and 2% internal fluorochemical (from an internal fluorochemical (IFC) polypropylene concentrate containing 80 percent by weight polypropylene and 20 percent by weight fluorochemical, available from Standridge Chemical Corporation, Social Circle, Ga.). Standard spunbonding conditions were used.

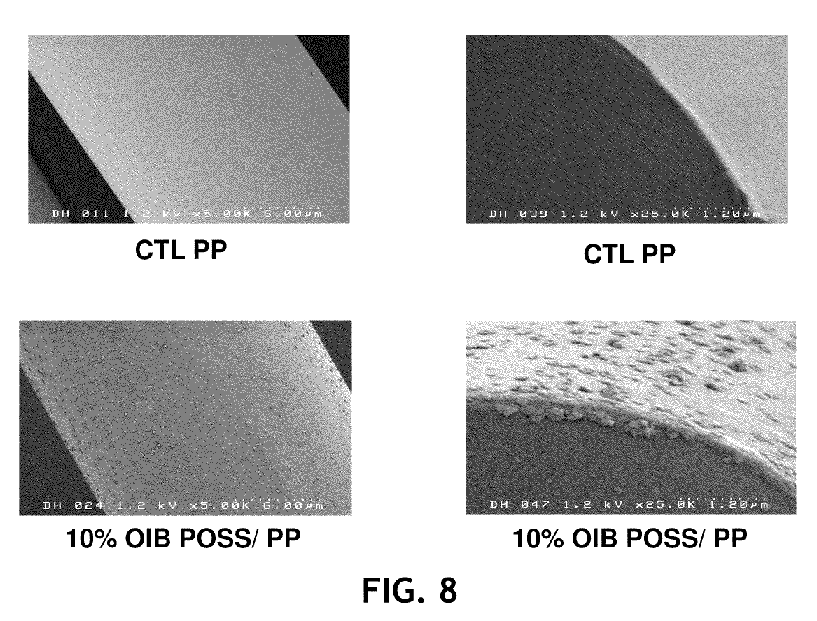

Referring to FIG. 8, SEMS of spunbond polypropylene fibers both with and without nanotopography generated from a POSS internal additive are shown.

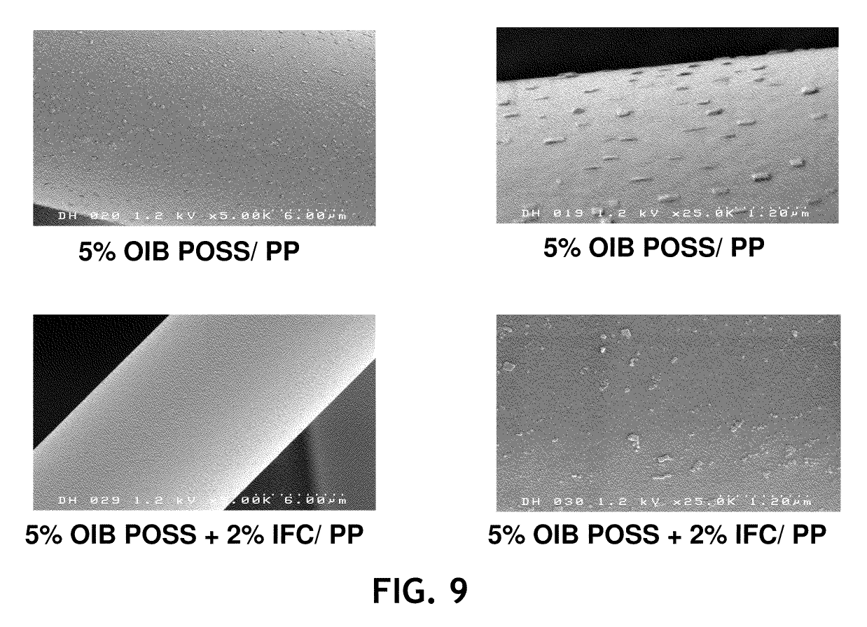

Referring to FIG. 9, SEMS of spunbond polypropylene fibers with and without the internal additives are shown. As with the films, the POSS/PP spunbond fiber samples show well dispersed and uniform nanotopography, while the POSS+IFC/PP spunbond fiber sample has topography that is either not evident, or is larger, less uniform, and less well dispersed. As with the films, it is evident that the internal fluorochemical inhibits the formation of well dispersed and uniform nanotopography generated from a POSS internal additive.

Meltblown Fabric Samples:

Meltblown fabric samples were made with standard meltblowing conditions. A polymer blend containing about 9 parts by weight polypropylene (3746 G polypropylene, ExxonMobil Chemical Corporation) and 1 part by weight polybutylene (DP-8911, LyondellBasell) was used.

Meltblown polypropylene fabric samples were also produced with the blend described above and containing 2 percent and 4% OIB POSS (Hybrid Plastics MS0825 nanoreinforced polypropylene). Further samples were produced that contained 1.2% internal fluorochemical (from an internal fluorochemical (IFC) polypropylene concentrate containing 80 percent by weight polypropylene and 20 percent by weight fluorochemical, available from Standridge Chemical Corporation, Social Circle, Ga.) by itself, and 1.2 % internal fluorochemical and 4 percent OIB POSS). Standard meltblowing conditions were used.

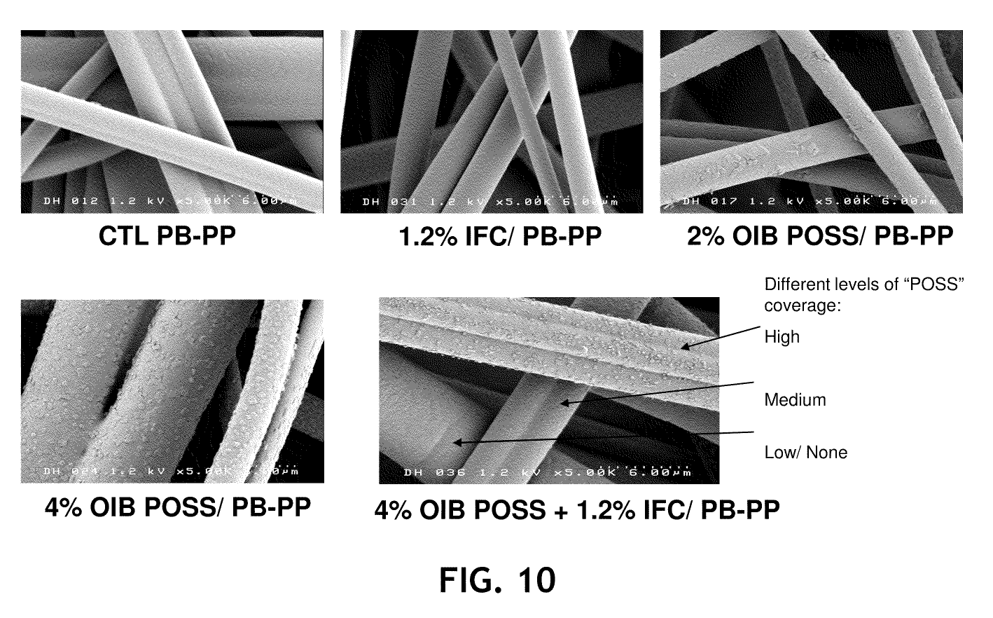

Referring to FIG. 10, SEMs of meltblown polypropylene/polybutylene fibers with and without the internal additives are shown. As with the films, the POSS/PP meltblown fiber samples show well dispersed and uniform nanotopography, especially at the 4% POSS level. For the POSS+IFC/PP meltblown fiber samples, the presence of topography depends on fiber size, with smaller fibers exhibiting topography, but larger fibers showing reduced levels of topography or no topography at all. Thus, it is evident that the internal fluorochemical inhibits the formation of well dispersed and uniform nanotopography in larger sized fibers.

While the embodiments of the invention disclosed herein are presently preferred, various modifications and improvements can be made without departing from the spirit and scope of the invention. The scope of the invention is indicated by the appended claims, and all changes that fall within the meaning and range of equivalents are intended to be embraced therein.

What is claimed is:

1. A method of making a high repellency material comprising the steps of:
providing a polymeric material having an external surface, the external surface comprising particle-like nanotopography;
etching the external surface with a high energy surface treatment; and
depositing a fluorochemical onto the etched external surface by a plasma fluorination process.

2. The method of claim 1, wherein the polymeric material comprises between about 1 and about 20 weight percent of a polyhedral oligomeric silsesquioxane compound.

3. The method of claim 1, wherein the polymeric material comprises between about 40 and about 99 weight percent of a base polymer.

4. The method of claim 3, wherein the base polymer is a polyolefin.

5. The method of claim 1, wherein the step of providing the polymeric material comprises a step of blending a polyhedral oligomeric silsesquioxane additive with a base polymer, followed by extruding the blend into the polymeric material having an external surface.

6. The method of claim 1, wherein the step of providing the polymeric material comprises a step of applying a nano-particle treatment to the external surface of the polymeric material.

7. The method of claim 1, wherein the high energy surface treatment comprises plasma treatment.

8. The method of claim 7, wherein the plasma comprises a blend of an inert gas and a reactive gas.

9. The method of claim 8, wherein the plasma comprises a blend of oxygen and argon.

10. The method of claim 9, wherein plasma comprises between about 1 and about 4 parts by weight oxygen and between about 1 and about 4 parts by weight argon.

11. The method of claim 1, wherein the fluorochemical comprises fluoracrylate monomer.

12. The method of claim 1, wherein the polymeric material is selected form the group consisting of films and fibers.

13. A high repellency material made by the process of claim 1.

14. A personal care product comprising a high repellency material made by the process of claim 1.

15. A high repellency synthetic polymeric article, the article having particle-like nanotopography on an external polymeric surface of the article, the external polymeric surface of the article having thereon a fluorochemical applied by plasma deposition, the external polymeric surface demonstrating a contact angle to water of greater than 140 degrees.

16. The high repellency synthetic polymeric article of claim 15, wherein the article is a film.

17 A method of making a high repellency material comprising the steps of:
providing a polymeric material having an external surface;
etching the external surface with a high energy surface treatment;
applying a nano-particle surface treatment formulation to the etched external surface of the polymeric material; and thereafter applying a fluorochemical onto the nano-particle treatment.

18. The method of claim 17, wherein the nano-particle surface treatment formulation comprises silica nano-particles.

19. The method of claim 17, wherein the high energy surface treatment comprises plasma treatment.

20. The method of claim 17, wherein the fluorochemical comprises fluoracrylate monomer.
